(19) United States
(12) Patent Application Publication
(10) Pub. No.: US 2010/0289906 A1
(43) Pub. Date: Nov. 18, 2010

(54) Interactive Student Response And Content Sharing System

(75) Inventors: Stephen T. Kaye, Ellicott City, MD (US); Sean Lee McKeever, Surprise, AZ (US)

Correspondence Address: MANELLI DENISON & SELTER, 2000 M STREET NW SUITE 700, WASHINGTON, DC, 20036-3307, US

(73) Assignee: eInstruction Corporation, Denton, TX (US)

(21) Appl. No.: 12/777,280

(22) Filed: May 11, 2010

Related U.S. Application Data
(60) Provisional application No. 61/177,691, filed on May 13, 2009.

(51) Int. Cl. H04N 5/228; H04N 5/225; H04N 5/76

(52) U.S. Cl. 348/207.11; 348/231.99; 348/222.1; 348/E05.024; 348/E05.031

(57) ABSTRACT

A personal response system 10 includes a plurality of camera assemblies 12 each having a camera 16 constructed and arranged to capture an image of information 18 on material that rests on a surface below the camera. Each camera assembly includes a transmitter 21 constructed and arranged to transmit the captured image in a wireless manner. A single receiver structure 22 is constructed and arranged to receive transmitted captured images from the camera assemblies. The receiver structure is constructed and arranged to be associated with a single host computer such that the captured images can be managed at the host computer.

This application claims the benefit of the earlier filing date of U.S. Provisional Application No. 61/177,691, filed on May 13, 2009, which is hereby incorporated by reference into this specification.

### FIELD

The invention relates to classroom teaching aids and, more particularly, to a personal response and document camera system for students.

### BACKGROUND

In the teaching environment, there has been a movement towards using technology to engage students in a collaborative manner. One type of collaborative system includes the use of hand-held remotes that enable students to input, via a keypad, answers to questions presented by the teacher. Each student can respond to the questions via the remote and the remote transmits the response to the teacher's host computer for storage and grading. Although such a system is useful, there is a limit to the range of responses that can be entered and sent by the student via the hand-held remote. Generally, only discrete, closed end responses such as true-false, numeric or alphabetic answers can be entered into and sent by the hand-held remote. Only simple texting is also possible using the hand-held remotes.

Also, many classrooms employ a centrally located document camera, whereby a teacher or student can place content under the camera to share the content with others, typically by projecting the image for all to see. However, the single document camera is effective for group use, but is limited since it cannot capture multiple students' work product simultaneously or sequentially.

There is a need to provide a richer interactive student response and content sharing system that enables a way for a teacher to capture, interact with, share, evaluate and store every student's work product during a lesson as well as making the system accessible both inside and outside of a classroom.

### SUMMARY

An object of the invention is to fulfill the need referred to above. In accordance with the principles of an embodiment, this objective is obtained by providing an interactive response and content sharing system. The system includes a plurality of camera assemblies each having a camera constructed and arranged to capture an image of information on material that rests on a surface below the camera. Each camera assembly includes a transmitter constructed and arranged to transmit the captured image in a wireless manner. A single receiver structure is constructed and arranged to receive transmitted captured images from the camera assemblies. The receiver structure is constructed and arranged to be associated with a single host computer such that the captured images can be managed at the host computer.

In accordance with another aspect of an embodiment, a method of capturing images of information associated with students in a classroom environment provides a camera assembly on a desk of at least two students in a classroom. Each camera assembly includes a camera. An image of information on material that rests on an associated desk is captured with each camera. The captured images are transmitted to a single receiver structure. The captured images received by the receiver structure are stored.

In accordance with another aspect of an embodiment, a camera assembly includes a base having a plurality of buttons. Each button is constructed and arranged to be engaged by a user and representing a discrete response of the user. An arm extends from the base. A camera is coupled to the arm so as to be spaced from the base. The camera is constructed and arranged to capture an image of information on material that rests on a surface below the camera. A storage medium is constructed and arranged to store the discrete response together with a captured image as a user's work product.

In accordance with yet another aspect of an embodiment, a method of capturing a user's work product captures an image of information that is associated with the user, captures a discrete response inputted by the user, and associates the captured image with the discrete response to define the user's work product.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of an interactive student response and content sharing system in accordance with an embodiment of the invention.

FIG. 2 is a top view of a camera assembly of the system of FIG. 1 shown resting on a student's desk to capture information in the camera's field of view.

FIG. 3 is a view similar to FIG. 2 but shown with an optional dry erase board for use in cases when paper is not available or appropriate.

FIG. 4 is an enlarged view of the student work product shown on the monitor in FIG. 1.

FIG. 5 is a system view of the personal response and document camera system of FIG. 1.

FIG. 6 is a view of the base of a camera assembly of the system of FIG. 1.

FIG. 7 is a view of another embodiment of a base of a camera assembly of the system of FIG. 1 showing the addition of a mouse pad and speaker.

### DETAILED DESCRIPTION OF THE EXEMPLARY EMBODIMENTS

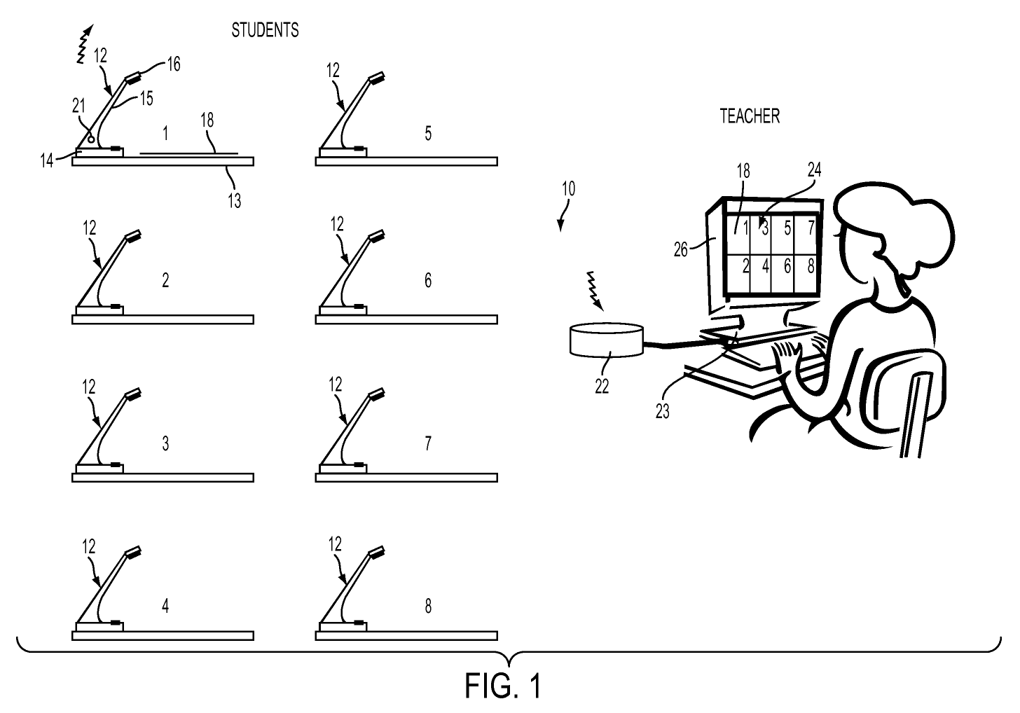

With reference to FIG. 1, an interactive student response and content sharing system is shown, generally indicated at 10, in accordance with an embodiment. The system 10 includes a plurality of portable camera assemblies, generally indicted at 12. In the embodiment, one camera assembly 12 rests on each student's desk 13. At least two camera assemblies 12 are part of the system 10 but the number of camera assemblies 12 provided can be equal to the number of students in the classroom. In the embodiment, eight camera assemblies 12 are provided on student desk locations numbered 1-8 in FIG. 1. The base 14 of each camera assembly 12 is preferably weighted so as to remain in a generally fixed position on the associated desk 13. Alternatively, the base 14 can be removably clamped or permanently mounted to a desk.

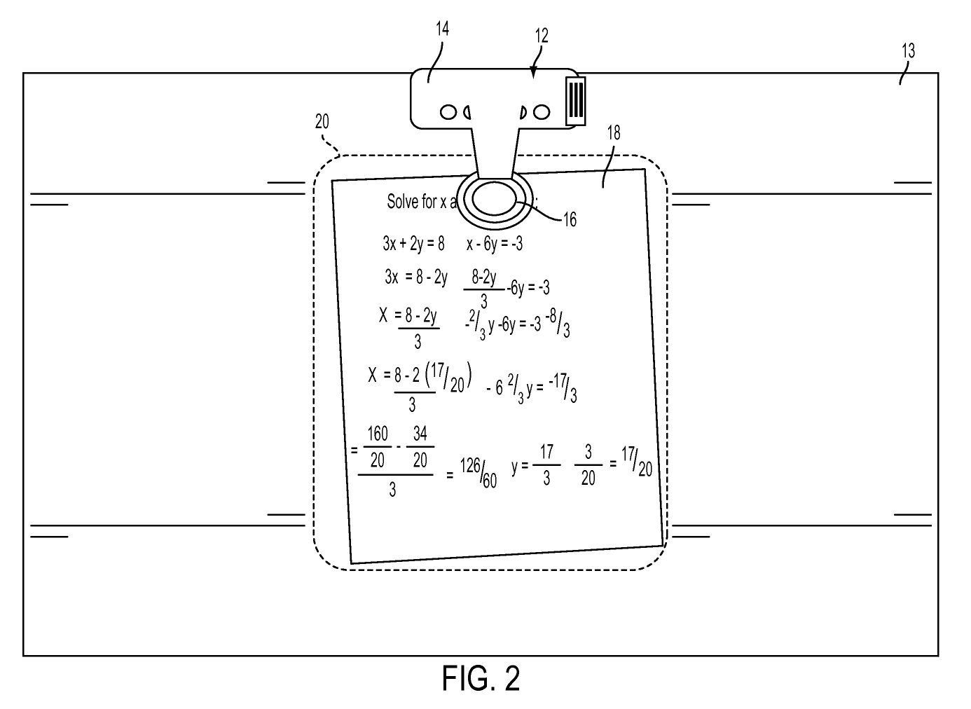

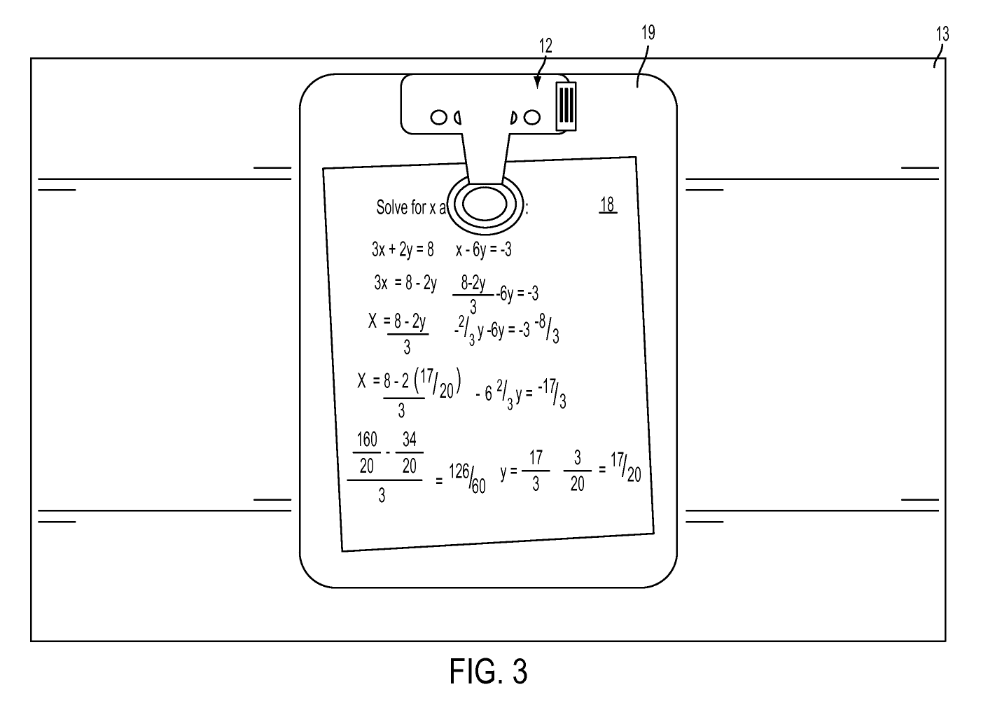

Each camera assembly 12 includes a low-resolution, battery powered camera 16 coupled to an arm 15 that extends from the base 14 so that the camera 16 is spaced from the base 14. The camera 16 preferably has an engineered lens designed to correct image distortion. In the embodiment, the camera 16 has a CMOS sensor, 640×480 pixel video and photo resolution. With reference to FIG. 2, each camera 16 is constructed and arranged to digitally capture an image of each student's information or work 18 in a field of view 20 below the camera 16. Thus, the field of view 20 is slightly larger than 8.5″×11″. The information or work 18 can be, for example, paper, worksheets, maps, diagrams or any other black and white or color document or any physical 3-dimensional object. Standard writing instruments can be used on the work 18. FIG. 3 shows an optional dry erase board 19 that defines the optimal image capture area and can be used in cases when paper is not available or appropriate.

Each camera 16 can capture a single frame of the information or work 18 or a near real time view, such as 30 frames/sec. Thus, as used herein, the term “captured image” means a single image or a plurality of images at a certain frame/sec. setting. Each camera assembly 12 is constructed and arranged such that the camera 16 is spaced above or over the information or work 18.

The captured image of the information or work 18 is transmitted wirelessly, via a transmitter, preferably a transceiver 21, associated with each camera assembly 12, to a common receiver structure 22, such as a receiver or transceiver, associated with the teacher's single host computer 23. Communication between the camera assemblies 12 and the receiver structure 22 can be RF communication. An addressing scheme for the camera assemblies 12 can be of the type disclosed in U.S. Pat. No. 6,930,673, the content of which is hereby incorporated into this specification by reference.

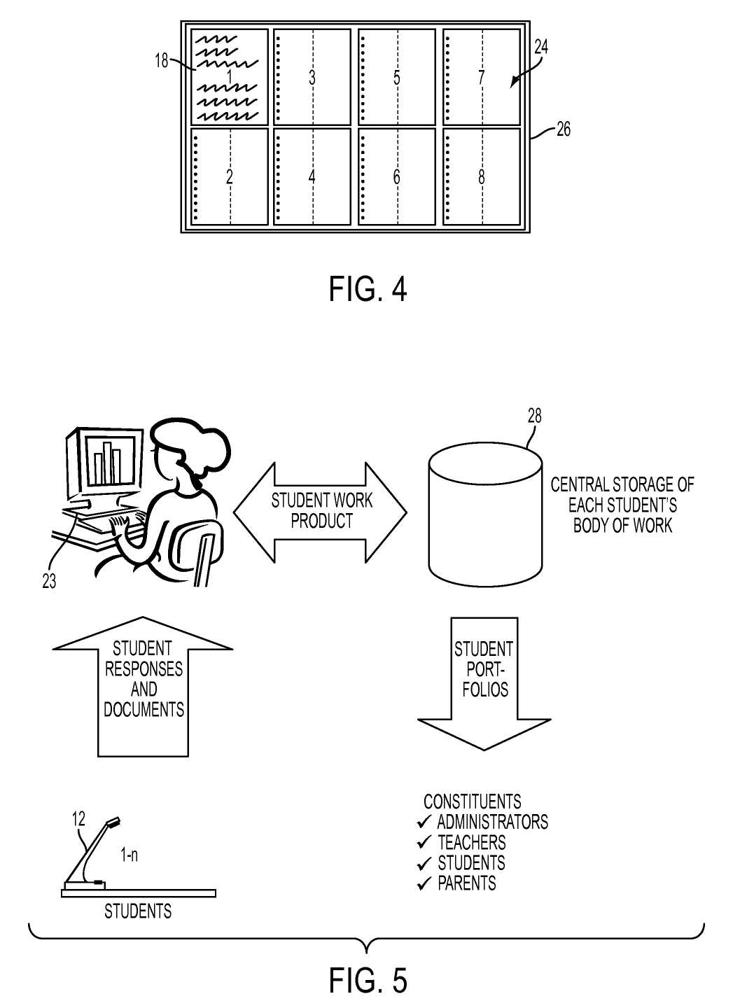

The teacher's host computer 23 includes content management application(s) for managing the information received from the camera assemblies 12. An example of such an application is eInstruction Corporation's “eI Cornerstone Education Suite” software. The teacher can pan around an image of each student's information or work 18, select an image to feature for review, for grading, or for classroom sharing and interaction. As shown in FIGS. 1 and 4, information 24 of at least one student or a plurality of students can be displayed on the teacher's computer monitor 26 and/or can be displayed on a larger display for the entire class to see. With reference to FIG. 5, a storage medium, defining a central database 28, is located at the host computer 23 or managed through a dedicated application server. The database 28 digitally stores and manages each student's work product as a portfolio for grading by quarter, semester or year. The database for each student may be shared with other constituents such as curriculum specialists, school administrators or the student's parents if desired. The database is accessed or sent via the Internet to any location for immediate or later review, grading, etc. The host computer 23 can control operation of the camera assemblies 12 or the host computer 23 can hand-off control to a student or students.

The camera assemblies 12 have no image projection capabilities, e.g., they are not projectors, since the captured images are stored at the teacher's host computer and can then be displayed by the teacher for students to see via a single projector coupled with the host computer.

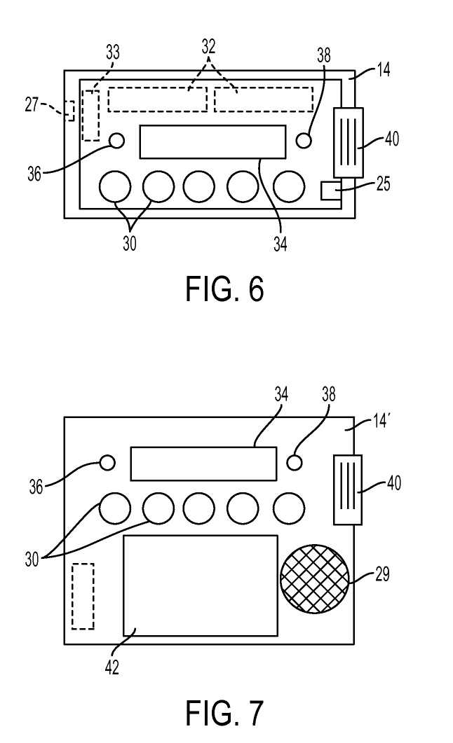

With reference to FIG. 6, each base 14 of a camera assembly 12 preferably includes buttons 30 defining a response pad that can be used by the student to provide discrete responses to teacher's questions, in a manner similar to the use of the hand-held remotes mentioned above. For example, if a multiple choice math question is presented by the teacher that requires the student to solve an equation in order to attain the answer, each student can respond by engaging the appropriate button 30 on the pad. Since the student's handwritten work 18 is also captured digitally by the camera 16, that work 18 can be associated and sent along with the discrete response to define a student's work product, thus comprising a complete or integrated response to a particular question. Thereafter, the teacher can review the work 18 (or thought process) associated with the discrete response and grant partial credit, and/or determine exactly how the student made an error.

Although the buttons 30 are described for inputting discrete responses, the buttons 30 can be in the form of a keyboard. An optional microphone 25 and/or headphone jack 27 (FIG. 6) or speaker 29 (FIG. 7) can be provided in the base 14. Thus, if the teacher wants to audibly communicate with a particular student, the student can listen to the teacher via the speaker or headphone and can speak to the teacher via the microphone. Also, the teacher could provide a recorded question or audio clip that each student could listen to as part of a question. The microphone option at the camera assemblies 12 also provides a more robust two-way interaction between each student and a remote instructor.

As shown in FIG. 6, since the camera assembly 12 is battery operated, batteries 32 can be stored in the base 14. An LCD display 34 can be provided on each base 14, allowing the student to view the time remaining for a particular question or test, which questions they have answered or not answered, the specific student's results thus far, or other information. The LCD display 34 can also be used by the teacher to send either global or individual messages to the students for viewing if desired. A low battery LED indicator light 36 is preferably provided on the base 14 along with an LED mode indicator light 38. Light 38 can indicate the mode “single frame” by one color of light and the real time or “continuous” mode by another color of light. Finally, a capture/send button 40 is provided on the base 14 which can be activated by the student once the student wants to capture his work 18 via the camera 16 and send the captured work wirelessly to the teacher's computer in the manner discussed above.

Each camera assembly 12 has local memory or storage medium 33, preferably in the base 14, for storing each student's work product prior to being sent to the receiver structure 22. In this way, transmission of the locally stored work product of multiple students can be prioritized since bandwidth is limited. Since there is a local storage medium 33, a student can take the camera assembly 12 home, enter discrete responses via buttons 30 and have the camera assembly 12 capture his work 18, with this overall work product being saved. The student can then return the camera assembly 12 to the classroom and transmit the work product to the receiving structure 22. Alternatively, the camera assembly 12 can be connected to the Internet using Wi-Fi or a wired connection so that the student, while still at home, can transmit his work product over the Internet to a the teacher. The teacher can respond to the transmission by providing the student with a grade for his work product.

With reference to FIG. 7, another embodiment of a base 14′ of a camera assembly 12 is shown. The base 14′ is similar to base 14 of FIG. 6, but includes a mouse pad 42 and the speaker 29. A digitizer type pen can also be integrated into the base 14 as another way to provide a pointing/mouse function. Instead of providing the mouse pad 42, remote mouse capability can be provided using image processing technology associated with the camera 16. In particular, the camera 16 can be set at the continuous mode to capture, for example, 30 frames/sec. A student's fingernail or finger can be tracked by the camera 16 and thus can function as a mouse or pointing device. The fingernail is a very good feature to track since it is inherently more reflective than skin and could be isolated from an imaging point of view. Left, right, up and down movements of the fingernail could be tracked so as to interact with instructional material at a basic level.

Other image processing techniques can be employed in the system 10. For example, instead of providing the buttons 30 for discrete responses, a physical object (e.g., numbered dice, paper) can be used as a response device by visually interpreting the image captured by the camera and converting the image to the proper character response.

Thus, the system 10 provides teachers with a simple yet powerful way to capture, interact with, share, evaluate and store every student's work for access both inside and outside of the classroom.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An interactive response and content sharing system comprising:
a plurality of camera assemblies, each camera assembly having a camera constructed and arranged to capture an image of information on material that rests on a surface below the camera, each camera assembly including a transmitter constructed and arranged to transmit the captured image in a wireless manner, and
a single receiver structure constructed and arranged to receive transmitted captured images from the camera assemblies, the receiver structure being constructed and arranged to be associated with a single host computer such that the captured images can be managed at the host computer.

2. The system of claim 1, in combination with the host computer, a display being associated with the host computer for displaying at least one captured image.

3. The system of claim 2, wherein the host computer is constructed and arranged to cause two or more of captured images to be displayed simultaneously.

4. The system of claim 1, wherein each camera assembly has a base and an arm extending from the base, the camera being coupled to the arm so as to be spaced from the base, the base being constructed and arranged to be mounted to or placed on a desk of a student in a classroom, and each camera assembly is absent an image projector.

5. The system of claim 1, wherein each camera is constructed and arranged to have a field of view to match a size of maximum allowable material that rests on the surface below the camera for capturing the image.

6. The system of claim 1, wherein the material, that contains the information that is captured by the camera, is paper, a dry erase board, or a physical 3-dimensional object.

7. The system of claim 1, wherein each camera assembly has a base, each base having a plurality of buttons, each button being constructed and arranged to be engaged by a user and representing a discrete response of the user, the transmitter being constructed and arranged to transmit the discrete response to the receiver structure along with the captured image.

8. The system of claim 7, wherein the base further includes a mouse pad.

9. The system of claim 7, wherein the base further includes an LCD display and a capture button constructed and arranged to be engaged to capture the image of the information and to cause the captured image to be sent to the receiver structure.

10. The system of claim 7, wherein the base further includes a microphone and means for receiving audio.

11. The system of claim 1, wherein each camera assembly includes local storage for storing the captured images.

12. The system of claim 1, wherein the receiver structure is a receiver/transmitter and is constructed and arranged to receive transmitted captured images from the camera assemblies and to send other information or commands to all or certain camera assemblies.

13. The system of claim 7, wherein each camera assembly includes local storage for storing the discrete response and the captured image as student work product.

14. A method of capturing information associated with students in a classroom environment, the method comprising:
providing a camera assembly on a desk of each of at least two students in a classroom, each camera assembly including a camera,
capturing with at least one of the cameras, an image of information on material that rests on an associated desk,
transmitting the captured image to a receiver structure in the classroom, and
storing the captured image received by the receiver structure.

15. The method of claim 14, wherein the method further includes capturing images with each of the cameras and displaying certain of the captured images.

16. The method of claim 14, further comprising, prior to the transmitting step, locally storing the captured image at the camera assembly that captured the image.

17. The method of claim 14, wherein each camera assembly has a base, each base having a plurality of buttons representing a discrete response of a student, the method further comprising:
activating a button on the at least one camera assembly and transmitting the discrete response together with the captured image to the receiver structure as work product of a student.

18. The method of claim 17, further comprising, prior to the transmitting step, locally storing the work product.

19. The method of claim 14, further comprising receiving information, sent from a source, at all or certain of the camera assemblies.

20. The method of claim 18, wherein each camera assembly has a base, each base having an LCD display, the information received being displayed on the LCD display.

21. The method of claim 19, further comprising:
providing a host computer as the source, the storing step comprising storing the captured images on a storage medium associated with the host computer, and wherein the receiver structure is a receiver/transmitter associated with the host computer.

22. The method of claim 14, further comprising:
visually interpreting an image captured by at least one of the cameras, and
converting the interpreted, captured image to a character response.

23. The method of claim 14, further comprising:
tracking with at least one of the cameras, a portion of a students finger so that the portion of the student's finger functions as a mouse or pointing device.

24. A camera assembly comprising:
a base having a plurality of buttons, each button being constructed and arranged to be engaged by a user and representing a discrete response of the user,
an arm extending from the base,
a camera coupled to the arm so as to be spaced from the base, the camera being constructed and arranged to capture an image of information on material that rests on a surface below the camera, and
storage medium constructed and arranged to store the discrete response together with a captured image as a user's work product.

25. The camera assembly of claim 24, further comprising a transmitter constructed and arranged to transmit the work product.

26. The camera assembly of claim 24, wherein the base further comprises a microphone and means for receiving audio.

27. The camera assembly of claim 24, wherein the base further comprises a mouse pad and an LCD display.

28. A method of capturing a user's work product comprising steps of:
capturing an image of information that is associated with the user,
capturing a discrete response inputted by the user,
associating the captured image with the discrete response to define the user's work product.

29. The method of claim 28, wherein the step of capturing an image includes using a camera on portable camera assembly, and the step of capturing the discrete response includes recognizing user actuation of a button associated with the camera assembly as the discrete response.

30. The method of claim 28, further comprising transmitting and storing the user's work product.
